(19) United States
(12) Patent Application Publication
(10) Pub. No.: US 2009/0117955 A1
(43) Pub. Date: May 7, 2009

(54) MOBILE PHONE CAPABLE OF RAPIDLY SWITCHING TO HAVE MULTIPLE-MEDIA FUNCTION

(76) Inventor: Kuo-Jung LO, Hsin-Tien (TW)

Correspondence Address: HDLS Patent & Trademark Services, P.O. BOX 220746, CHANTILLY, VA, 20153-0746, US

(21) Appl. No.: 11/936,328

(22) Filed: Nov. 7, 2007

(51) Int. Cl. H04M 1/00

(52) U.S. Cl. 455/575.3

(57) ABSTRACT

A mobile phone capable of switching to have a multiple-media function rapidly includes a main body, a lifting cover and a switch. The main body is provided with a platen. The platen is provided thereon with a displaying screen. Both sides of the platen are provided with two accommodating sections. Each of the two accommodating sections is provided with operating buttons. Further, one side of the platen has a set of pivoting shafts for pivotally connecting with the lifting cover. The lifting cover is constituted of a first lifting cover and a second lifting cover. The inner and outer surfaces of the first lifting cover are provided with sound-outputting holes, and the interior thereof is provided with a speaker. The outer surface of the second lifting cover is provided with a plurality of buttons, and the inner surface thereof is provided with sound-outputting holes. One side of the first and second lifting covers is provided with two rotating shafts for pivotally connecting with the two pivoting shafts. The switch is provided on the mobile phone. After the lifting cover is lifted, the switch is turned on so as to switch the mobile-phone function to the multiple-media function.

### BACKGROUND OF THE INVENTION

1. Field of the Invention

The present invention relates to a mobile device, and in particular to a mobile phone capable of switching to a multiple-media function rapidly.

2. Description of Prior Art

Mobile phone has become an electronic communication product that is necessarily carried by people every day. At an earlier stage, the mobile phone only provides a user with a function of dialing and receiving a call. With the continuous progress of modern technology, the current mobile phone has already been integrated with an associated electronic device such as peripheral audio-video product or video game player, thereby forming a new-generation portable mobile multiple-media communication device. In the case of an audio-video system or video game player is integrated in a mobile phone, a user can put on an earphone or external sound effect device to listen to MP3 music, watch movies or play video games built in the mobile phone when his/her mobile phone is in a standby state (as disclosed in Taiwan Patent Publication Nos.M285873 and M308596). When listening to the MP3 music or watching movies, the user has to press a plurality of operating buttons on the mobile phone to enter the music database or movie database to perform the playing of the music or movie. Similarly, when playing the video games, the user has to press the plurality of operating buttons on the mobile phone to enter the game database to perform the selected video game. At this time, a program built in the mobile phone will switch some buttons of the button group to operating buttons for controlling the video game, thereby allowing the user to control the video game. However, these operating buttons are arranged together with the original button, and thus the user may press wrong buttons when playing the video games.

Therefore, it is an important issue for the present invention to provide a solution of rapidly switching the mobile phone in a standby state to a multiple-media function.

### SUMMARY OF THE INVENTION

In order to overcome the drawbacks of prior art, the present invention is to provide a device for switching a mobile-phone function to have a multiple-media function directly, thereby avoiding complicated operating process of pressing a plurality of buttons and allowing the user to use the multiple-media function rapidly.

The present invention provides a mobile phone capable of rapidly switching to have a multiple-media function, which includes a main body, a lifting cover and a switch. The main body is provided with a platen. The platen is provided thereon with a displaying screen. Both sides of the platen are provided with two recessed accommodating sections. Each of the two accommodating sections is provided with at least one operating buttons. Further, one side of the platen has a set of pivoting shafts for pivotally connecting with the lifting cover. One side of the two accommodating sections is provided with a recessed portion to correspond to the pivoting shaft, and the other side has a recessed notch. The lifting cover is constituted of a first lifting cover and a second lifting cover. The inner and outer surfaces of the first lifting cover are provided with sound-outputting holes while the interior of the first lifting cover is provided with a speaker. The outer surface of the second lifting cover is provided with a plurality of buttons, and the inner surface thereof is provided with sound-outputting holes. One side of the first and second lifting covers is provided with two rotating shafts for pivotally connecting with the two pivoting shafts.

### BRIEF DESCRIPTION OF THE DRAWINGS

FIG. 1 is a perspective view showing the external appearance of the mobile phone of the present invention;

FIG. 2 is a front view showing the mobile phone of the present invention;

FIG. 3 is an exploded view showing the mobile phone of the present invention;

FIG. 4 is a schematic view showing the operating procedure of the mobile phone of the present invention;

FIG. 5 is a schematic view showing another embodiment of the present invention;

FIG. 6 is a schematic view showing a further embodiment of the present invention; and

FIG. 7 is a schematic view showing still a further embodiment of the present invention.

### DETAILED DESCRIPTION OF THE INVENTION

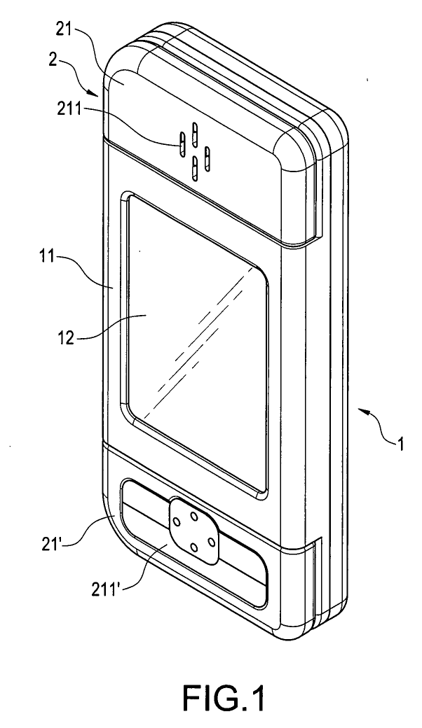

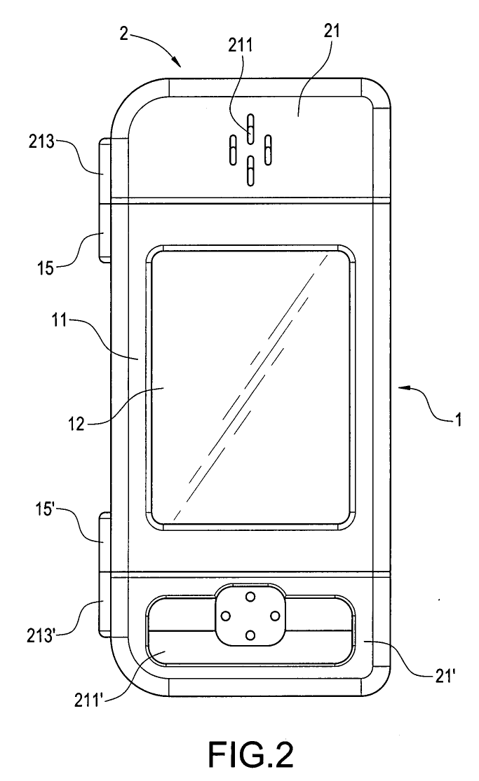

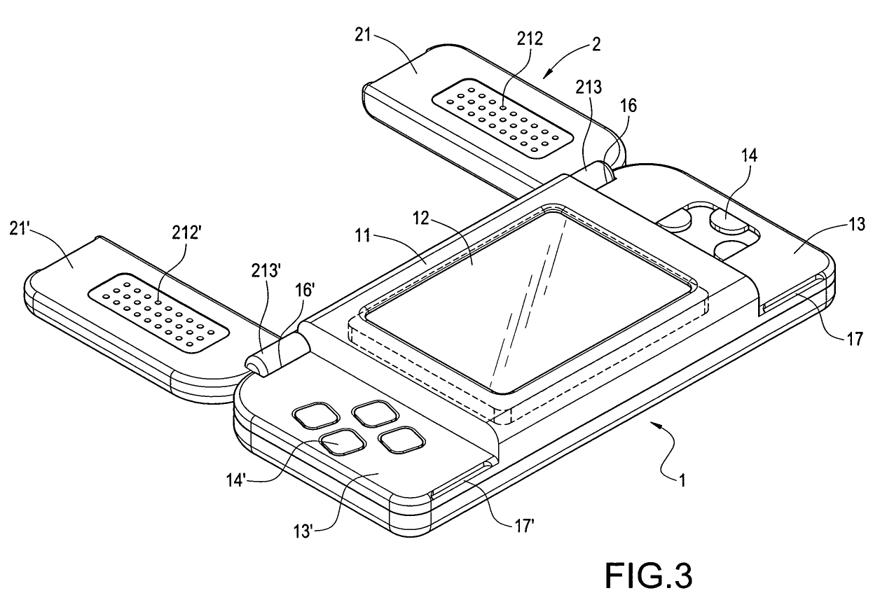

The technical contents and the detailed description of the present invention will be explained with reference to the accompanying drawings. FIG. 1 is a perspective view showing the external appearance of the mobile phone of the present invention. FIG. 2 and FIG. 3 are a front view and an exploded view showing the mobile phone of the present invention, respectively. As shown in these figures, according to the present invention, the device for switching a mobile phone to a multiple-media function includes a main body 1 and a set of lifting covers 2.

The main body 1 is provided with a protruding platen 11. The platen 11 is provided thereon with a displaying screen 12. When the main body 1 is in a mobile phone standby mode, the displaying screen 12 can display the pictures for the mobile phone, such as various operating buttons, icons, dynamic or static images, characters and data. If the device is switched to the multiple-media function, the displaying screen 12 can display the pictures for the multiple media, such as movies or video games. Further, both sides of the platen 11 are provided with two recessed accommodating sections 13, 13′. Each of the two accommodating sections 13, 13′ is provided with at least one operating buttons 14, 14′. The operating buttons 14, 14′ allow the user to play the movie or the video game. Further, one side of the platen 11 has a set of pivoting shafts 15, 15′. The two pivoting shafts 15, 15′ are used to be pivotally connected with the set of lifting covers 2. One side of the two accommodating sections 13, 13′ is provided with two recessed portions 16, 16′ to correspond to the two pivoting shafts 15, 15′, and the other side thereof has a recessed notch 17, 17′ respectively. The two notches 17, 17′ allow a portion of the finger of the user to get therein, thereby separating the set of lifting covers 2 from the main body 1. In the drawings, the displaying screen 12 is a touch screen that is either one of a resistance-type or a capacitor-type.

The set of lifting covers 2 is constituted of a first lifting cover 21 and a second lifting cover 21′ disposed in the two accommodating sections 13, 13′. Outer and inner surfaces of the first lifting cover 21 are provided with sound-outputting holes 211, 212 for outputting the sound generated by a speaker (not shown) within the first lifting cover 21. One side of the first lifting cover 21 is provided with a rotating shaft 213 for pivotally connecting with the pivoting shaft 15. When the rotating shaft 213 rotates, it rotates in the recessed portion 16. An outer surface of the second lifting cover 21′ is provided with a plurality of buttons 211′ for performing various operations of the mobile phone. The inner surface of the second lifting cover 21′ is provided with sound-outputting holes 212′ for outputting the sound generated by a speaker (not shown) within the second lifting cover 21′. One side of the first lifting cover 21′ is provided with a rotating shaft 213′ for pivotally connecting with the pivoting shaft 15′. When the rotating shaft 213′ rotates, it rotates in the recessed portion 16′. When the first and second lifting covers 21, 21′ cover the two accommodating sections 13, 13′, the outer surfaces of the first and second lifting covers 21, 21 ′ are at the same height as the surface of the platen 11, thereby achieving the flatness of the whole outer surface.

After the first lifting cover 21 and the second lifting cover 21′ are lifted, the pivotal shafts 15, 15′ are brought into mechanical rotation contact with the interior of the rotating shafts 213, 213′, thereby acting as a switch to generate a signal. After the signal is transmitted to a microprocessor (not shown) within the main body 1 and is processed, the standby mode of the mobile phone can be switched to the multiple-media function. At this time, the user can perform the multiple-media function while the mobile-phone function is inactive.

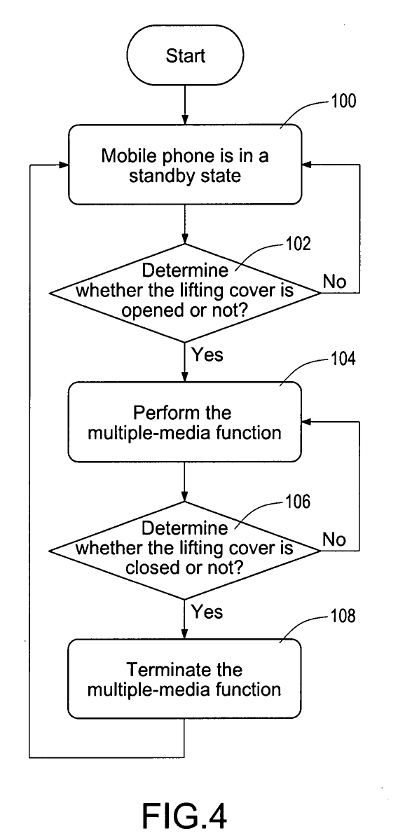

FIG. 3 is an exploded view showing the mobile phone of the present invention, and FIG. 4 is a schematic view showing the operating procedure of the mobile phone of the present invention. As shown in these figures, when the mobile phone is in use, it is in a standby state first (step 100).

In the step 102, a program built in the mobile phone determines whether the set of lifting covers 2 is opened or not. If it is determined that that the set of lifting covers 2 is not opened, the procedure returns to the step 100. If it is determined that the set of lifting covers 2 is opened, the procedure proceeds to the step 104, a program built in the mobile phone starts to switch the mobile phone standby mode to the multiple-media function (such as playing video games or watching movies). At this time, the mobile-phone function is inactive.

In the step 106, the program built in the mobile phone determines whether the set of lifting covers 2 is closed or not. If it is determined that the set of lifting covers 2 is closed, the procedure proceeds to the step 108 to terminate the multiple-media function and returns to the step 100. If it is determined that the set of lifting covers 2 is not closed, the procedure returns to the step 104 to continue performing the multiple-media function.

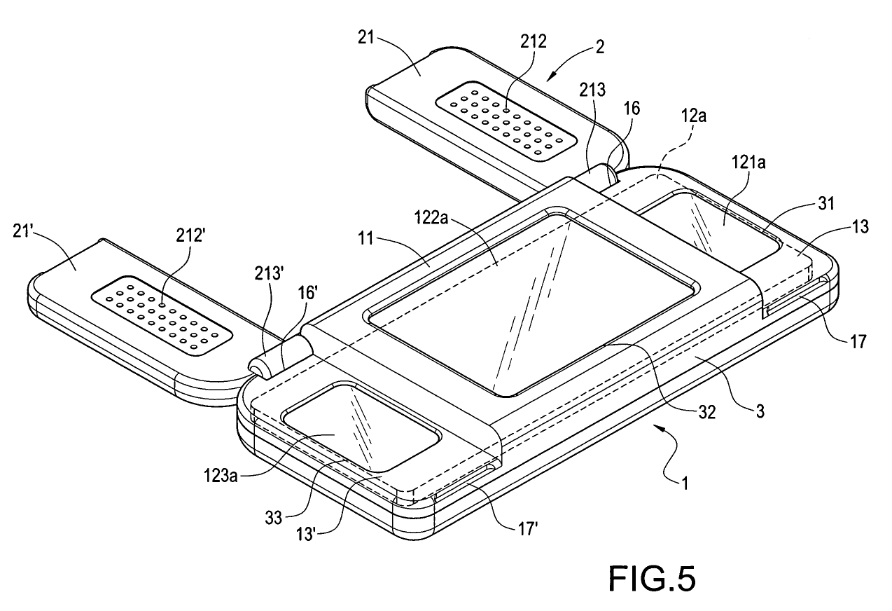

With reference to FIG. 5, it is a schematic view showing another embodiment of the present invention. As shown in this figure, the mobile phone disclosed in this figure is substantially the same as that shown in FIGS. 1 to 3. The only difference lies in that the displaying screen 12a of the main body 1 is a full screen (as shown in dotted lines). The surface of the displaying surface 12a is attached with a protruding cover 3. The cover 3 is provided with a first window 31, a second window 32 and a third window 33. The cover 3 covers on the surface of the displaying screen 12a for dividing the displaying screen 12a into three small-sized displaying screens, i.e. a first displaying screen 121a, a second displaying screen 122a and a third displaying screen 123a. The second displaying screen 122a is used to display the pictures for the mobile phone, such as various operating button icons, dynamic or static images, characters and data. The first and third displaying screens 121a and 123a are used to display the operating button icons for the multiple media.

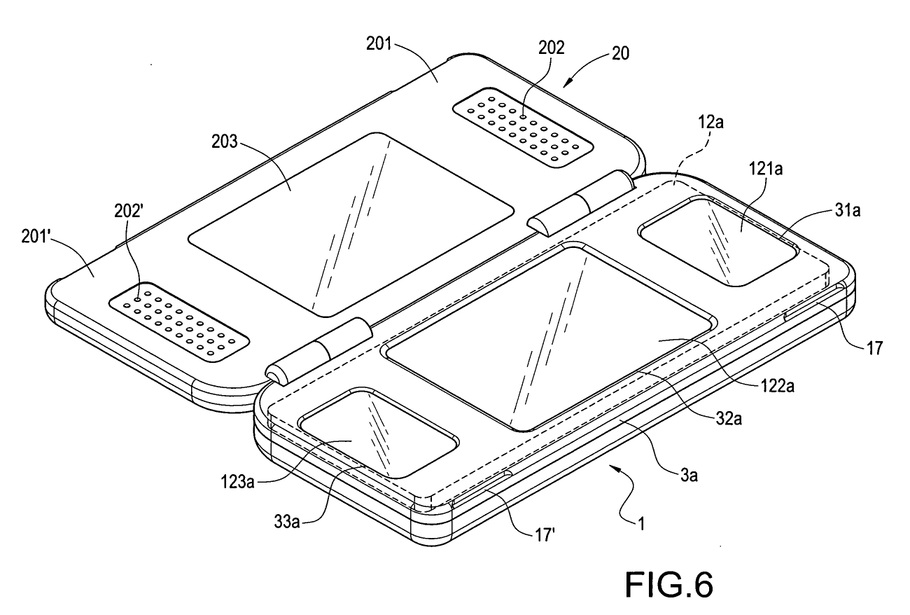

With reference to FIG. 6, it is a schematic view showing a further embodiment of the present invention. As shown in this figure, the mobile phone disclosed in this figure is substantially the same as that shown in FIGS. 1 to 3. The only difference lies in that the displaying screen 12a of the main body 1 is a full screen (as shown in dotted lines). The surface of the displaying surface 12a is attached with a cover 3a. The cover 3a is provided with a first window 31a, a second window 32a and a third window 33a. The cover 3a covers on the surface of the displaying screen 12a for dividing the displaying screen 12a into three small-sized displaying screens, i.e. a first displaying screen 121a, a second displaying screen 122a and a third displaying screen 123a. The second displaying screen 122a is used to display the pictures for the mobile phone, such as various operating button icons, dynamic or static images, characters and data. The first and third displaying screens 121a and 123a are used to display the operating button icons for the multiple media.

The area and shape of the lifting cover 20 are the same as those of the main body 1. The outer and inner surfaces of the casing 201 on one side of the lifting cover 20 are provided with sound-outputting holes 202 for outputting the sound generated by a speaker (not shown) within the casing 201. The outer surface of the casing 201′ on the other side is provided with a plurality of buttons (not shown) for performing various operations of the mobile phone. The inner surface of the casing 201′ is provided with sound-outputting holes 202′. A transparent window 203 is provided in the center of the lifting cover 20. The transparent window 203 allows the user to see the pictures for the mobile phone (such as various operating buttons, icons, dynamic or static images, characters and data) via the outer surface of the lifting cover 20.

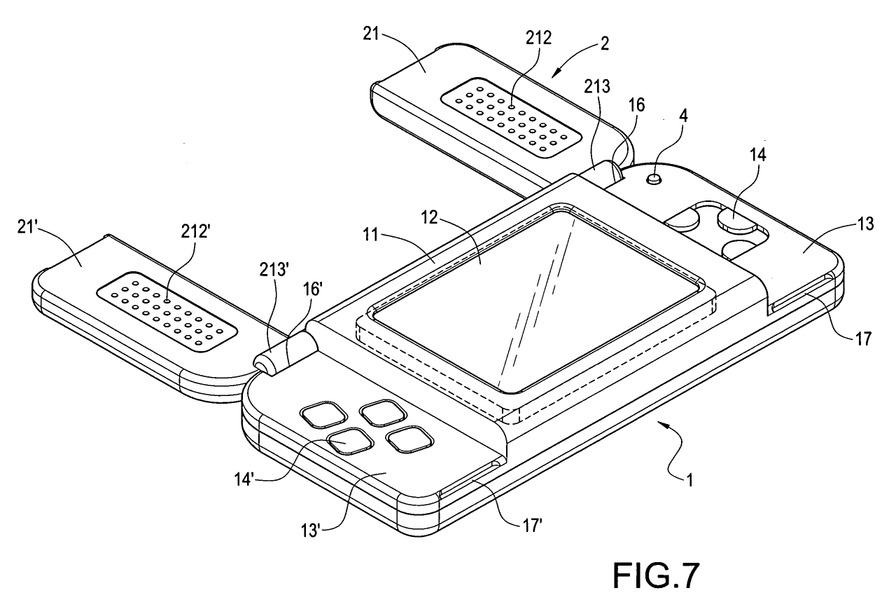

With reference to FIG. 7, it is a schematic view showing still a further embodiment of the present invention. As shown in this figure, the mobile phone disclosed in this figure is substantially the same as that shown in FIGS. 1 to 3. The only difference lies in that one side of the main body 1 is provided with a press button 4 for acting as a switch. When the first lifting cover 21 and the second lifting cover 21′ of the set of lifting covers 2 are closed, the first lifting cover 21 will press the button 4, so that the button 4 is turned off. At this time, the mobile phone is in the standby mode. When the first lifting cover 21 and the second lifting cover 21′ are lifted, the button 4 is not pressed by the first lifting cover 21 and thus bounds upwardly, so that the button 4 is brought into communication with the microprocessor (not shown). After the signal is transmitted to the microprocessor within the mobile phone and is processed, the program built in the microprocessor can switch the mobile phone standby mode to the multiple-media function. At this time, the communicating function of the mobile phone is inactive, so that the user can only perform the multiple-media function.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A mobile phone capable of rapidly switching to have a multiple-media function, comprising:
a main body having a platen and two accommodating sections arranged on both sides of the platen, the platen having a displaying screen thereon, each of the accommodating sections being provided with at least one button;
a first lifting cover pivotally connected with the main body and having a built-in speaker;
a second lifting cover pivotally connected with the main body and provided with a plurality of buttons on a surface thereof, and
a switch provided on the mobile phone;
wherein the mobile phone is switched from a mobile-phone function to the multiple-media function after at least one of the two lifting covers is lifted to turn on the switch.

2. The mobile phone according to claim 1, wherein one side of the main body is provided with two pivotal shafts.

3. The mobile phone according to claim 1, wherein one side of the accommodating section is provided with a recessed portion to correspond to the pivoting shaft, and the other side thereof is provided with a recessed notch.

4. The mobile phone according to claim 1, wherein the displaying screen is a touch screen of a resistance-type or a capacitor-type.

5. The mobile phone according to claim 1, wherein the inner surfaces of the first and second lifting covers are provided with sound-outputting holes.

6. The mobile phone according to claim 1, wherein the outer surface of the first lifting cover is provided with sound-outputting holes.

7. The mobile phone according to claim 1, wherein the second lifting cover is provided with a speaker therein.

8. The mobile phone according to claim 1, wherein one side of the first and second lifting covers is provided with a rotating shaft for pivotally connecting with the pivotal shaft.

9. The mobile phone according to claim 1, wherein the switch generates an induction signal output with the two pivotal shafts being brought into mechanical rotation contact with the two rotating shafts.

10. The mobile phone according to claim 1, wherein the switch is a press button provided on the main body, the switch is turned on when not being pressed by the first lifting cover or the second lifting cover, so that the mobile phone is switched from the mobile-phone function to the multiple-media function.

11. A mobile phone capable of rapidly switching to have a multiple-media function, comprising:
a main body having a displaying screen thereon, the displaying screen having the same shape as that of the main body, a surface of the displaying screen being provided with a cover, the cover being provided thereon with a first window, a second window and a third window to allow the displaying screen to form a first displaying screen, a second displaying screen and a third displaying screen;
a lifting cover pivotally connected with the main body; and
a switch provided on the mobile phone;
wherein the switch is turned on after the lifting cover is lifted, so that the mobile phone is switched from the mobile-phone function to the multiple-media function.

12. The mobile phone according to claim 11, wherein the cover is protruding, the cover has a platen thereon, the first and second windows on both sides of the platen are provided with two accommodating sections, one side of the platen has two pivotal shafts, the two pivotal shafts are provided with two recessed portions, and the other side thereof is provided with a recessed notch.

13. The mobile phone according to claim 11, wherein the displaying screen is a touch screen and the touch screen is either one of a resistance-type or a capacitor-type.

14. The mobile phone according to claim 11, wherein the second displaying screen is used to display the pictures for the mobile phone, such as various functional button icons, figures, dynamic or static images, characters and data, and the first and second displaying screens are used to display the icons of the operational buttons for the multiple media.

15. The mobile phone according to claim 11, wherein the lifting cover is constituted of a first lifting cover and a second lifting cover, the outer and inner surfaces of the first lifting cover are provided with sound-outputting holes, the interior of the first and second lifting covers is each provided with a speaker, one side of the first and second lifting covers is provided with a rotating shaft for pivotally connecting with the pivotal shaft.

16. The mobile phone according to claim 15, wherein the outer surface of the second lifting cover is provided with a plurality of buttons and the inner surface thereof is provided with sound-outputting holes.

17. The mobile phone according to claim 11, wherein the outer and inner surfaces of a casing on one side of the lifting cover are provided with sound-outputting holes while the interior thereof is provided with a speaker, the outer surface of a casing on the other side of the lifting cover is provided with a plurality of buttons and the inner surface thereof is provided with sound-outputting holes, the casing is provided with a speaker therein, and the center of the lifting cover is provided with a transparent window.

18. The mobile phone according to claim 11, wherein the switch generates an induction signal output with the two pivotal shafts being brought into mechanical rotation contact with the two rotating shafts.

19. The mobile phone according to claim 11, wherein the switch is a press button provided on the main body, the switch is turned on when not being pressed by the first lifting cover or the second lifting cover, so that the mobile phone is switched from the mobile-phone function to the multiple-media function.
